(19) United States
(12) Patent Application Publication
(10) Pub. No.: US 2011/0278087 A1
(43) Pub. Date: Nov. 17, 2011

(54) AIRBAG SYSTEM

(75) Inventor: Yutaka OKAMOTO, Wako (JP)

(73) Assignee: HONDA MOTOR CO., LTD., Tokyo (JP)

(21) Appl. No.: 13/080,682

(22) Filed: Apr. 6, 2011

(30) Foreign Application Priority Data
May 12, 2010 (JP) 2010-110003

(51) Int. Cl. B60R 21/36

(52) U.S. Cl. 180/274

(57) ABSTRACT

An airbag system to protect a pedestrian includes a metal airbag and an inflator. The metal airbag is provided in a zigzag-folded state between a side end portion of a windshield of a vehicle and a front pillar projecting toward a front of a vehicle body with respect to the side end portion. The side end portion is an end portion of the windshield in a lateral direction of the vehicle body and is connected to the front pillar. The inflator is configured to generate gas to deploy the metal airbag along the front pillar. The metal airbag is folded such that a virtual line connecting each of peaks and one of valleys continuous with the peaks included in zigzag folds extends substantially in an front-rear direction of the vehicle body.

### CROSS-REFERENCE TO RELATED APPLICATIONS

The present application claims priority under 35 U.S.C. §119 to Japanese Patent Application No. 2010-110003, filed May 12, 2010, entitled “Airbag System”. The contents of this application are incorporated herein by reference in their entirety.

### BACKGROUND OF THE INVENTION

1. Field of the Invention

The present invention relates to an airbag system.

2. Description of the Related Art

There is a known pedestrian-protecting airbag system, disclosed in Japanese Unexamined Patent Application Publication No. 2002-283939, in which cloth airbags in a folded state are provided inside respective pillar garnishes covering the front faces of respective front pillars of a motor vehicle. Upon any impact with a pedestrian, gas generated by inflators is supplied to the airbags, and the airbags are deployed through respective gaps produced by pushing the pillar garnishes and expand along the front faces of the front pillars, whereby the pedestrian is protected.

Furthermore, there is a known pedestrian-protecting impact-absorbing mechanism, disclosed in Japanese Unexamined Patent Application Publication No. 2006-282105, in which pillar garnishes covering the front faces of respective front pillars of a motor vehicle are supported by respective pillar base members with respective link-type pillar-driving mechanisms interposed therebetween. Upon any impact with a pedestrian, the pillar-driving mechanisms lift the pillar garnishes from the pillar base members such that the pillar garnishes move through certain strokes, whereby the energy of the impact is absorbed.

### SUMMARY OF THE INVENTION

According to one aspect of the present invention, an airbag system to protect a pedestrian includes a metal airbag and an inflator. The metal airbag is provided in a zigzag-folded state between a side end portion of a windshield of a vehicle and a front pillar projecting toward a front of a vehicle body with respect to the side end portion. The side end portion is an end portion of the windshield in a lateral direction of the vehicle body and is connected to the front pillar. The inflator is configured to generate gas to deploy the metal airbag along the front pillar. The metal airbag is folded such that a virtual line connecting each of peaks and one of valleys continuous with the peaks included in zigzag folds extends substantially in an front-rear direction of the vehicle body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view showing a front part of a body of a motor vehicle according to embodiments of the present invention;

FIG. 2 is an enlarged cross-sectional view taken along line II-II shown in FIG. 1 and shows an airbag according to a first embodiment of the present invention;

FIGS. 3A and 3B are perspective views of the airbag according to the first embodiment;

FIG. 4 is an enlarged exploded perspective view of part IV shown in FIG. 3;

FIG. 5 is an enlarged perspective view of part V shown in FIG. 3;

FIG. 6 shows how the airbag shown in FIG. 2 is deployed;

FIG. 7 is an enlarged cross-sectional view taken along line VII-VII shown in FIG. 1 and shows an airbag according to a second embodiment of the present invention;

FIG. 8 is an enlarged cross-sectional view taken along line VIII-VIII shown in FIG. 1 and shows an airbag according to a third embodiment of the present invention; and

FIG. 9 is an enlarged cross-sectional view taken along line IX-IX shown in FIG. 1 and shows an airbag according to a fourth embodiment of the present invention.

### DESCRIPTION OF THE EMBODIMENTS

The embodiments will now be described with reference to the accompanying drawings, wherein like reference numerals designate corresponding or identical elements throughout the various drawings.

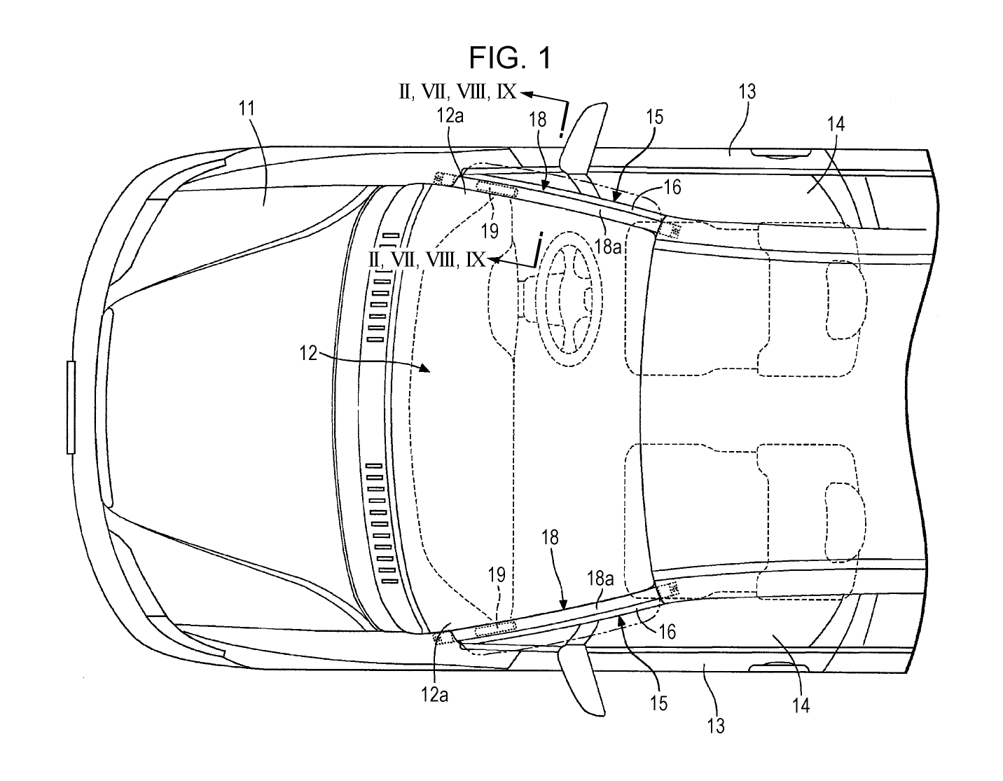

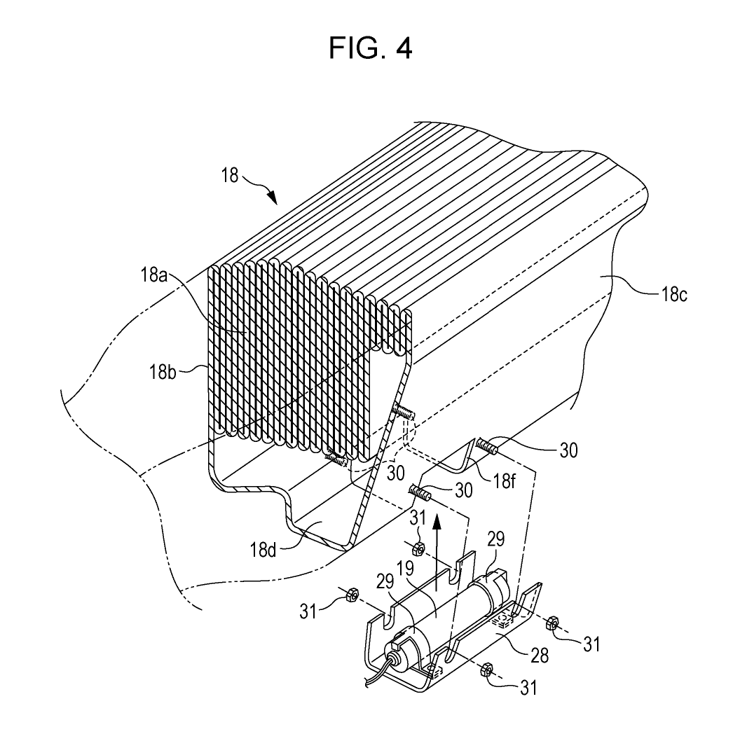

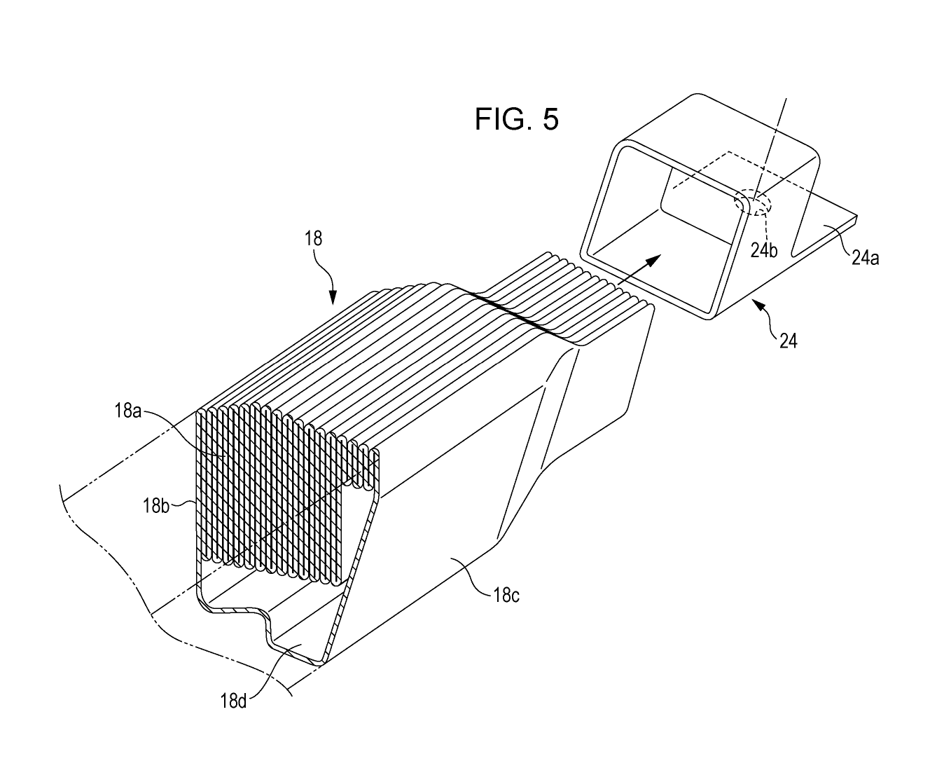

A first embodiment of the present invention will now be described with reference to FIGS. 1 to 6.

Referring to FIG. 1, a motor vehicle has a windshield 12 at the rear of a bonnet hood 11. Front pillars 15 are provided between respective lateral side ends 12a of the windshield 12 and door glasses 14 of respective front doors 13.

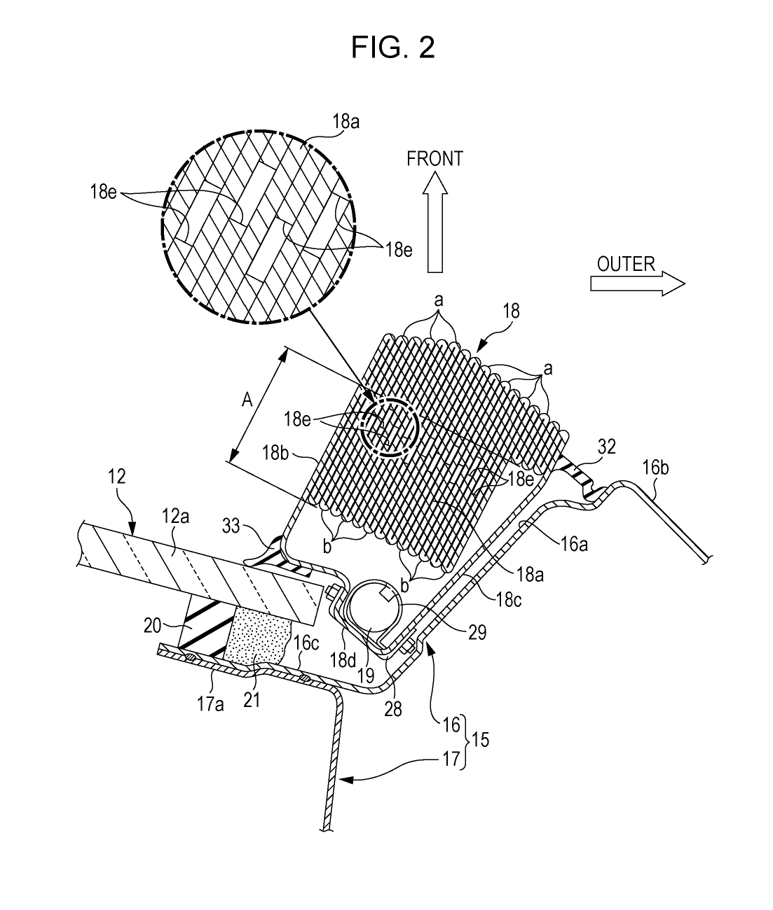

Referring to FIG. 2, each of the front pillars 15 includes an outer panel 16 and an inner panel 17 provided on the outer and inner sides, respectively, of the body of the vehicle. The outer panel 16 and the inner panel 17 are connected to each other, whereby the front pillar 15 has a closed cross section. A metal airbag 18 is provided in a folded state on a front face 16a of the outer panel 16. The airbag 18 also serves as a pillar garnish. Each of the side ends 12a of the windshield 12 is placed over the front face of a set of connected portions 16c and 17a of the outer and inner panels 16 and 17 with a dam rubber 20 interposed therebetween, and is bonded thereto with adhesive 21.

The airbag 18, which is a metal tube in a folded state, includes a zigzag-folded portion 18a, an inner sidewall portion 18b continuous with the zigzag-folded portion 18a on the inner side in the lateral direction (on the side nearer to the windshield 12), an outer sidewall portion 18c continuous with the zigzag-folded portion 18a on the outer side in the lateral direction (on the side nearer to the front face 16a of the outer panel 16), and an inflator-supporting portion 18d connecting the rear ends of the inner and outer sidewall portions 18b and 18c. Thus, the airbag 18 has a closed cross section. The zigzag-folded portion 18a is folded such that many peaks a and many valleys b are alternately and continuously formed. A virtual line connecting each of the peaks a and one of the valleys b continuous therewith extends substantially in the front-rear direction of the vehicle body. The tips of the peaks a are orderly provided in such a manner as to form a substantially flat surface as a whole facing toward the front of the vehicle body.

The outer sidewall portion 18c, facing the front face 16a of the outer panel 16, and the inflator-supporting portion 18d, facing the connected portion 16c of the outer panel 16, are hidden from the outside of the vehicle body. Meanwhile, the front face of the zigzag-folded portion 18a and the inner sidewall portion 18b are exposed between a side face 16b of the outer panel 16 of the front pillar 15 and the side end 12a of the windshield 12, and in combination serve as a pillar garnish.

Referring to the enlargement of the encircled part shown in FIG. 2, metal-sheet portions between the peaks a and valleys b of the zigzag-folded portion 18a of the airbag 18 are closely in contact with one another, with a plurality of vent holes 18e provided at appropriate positions thereof.

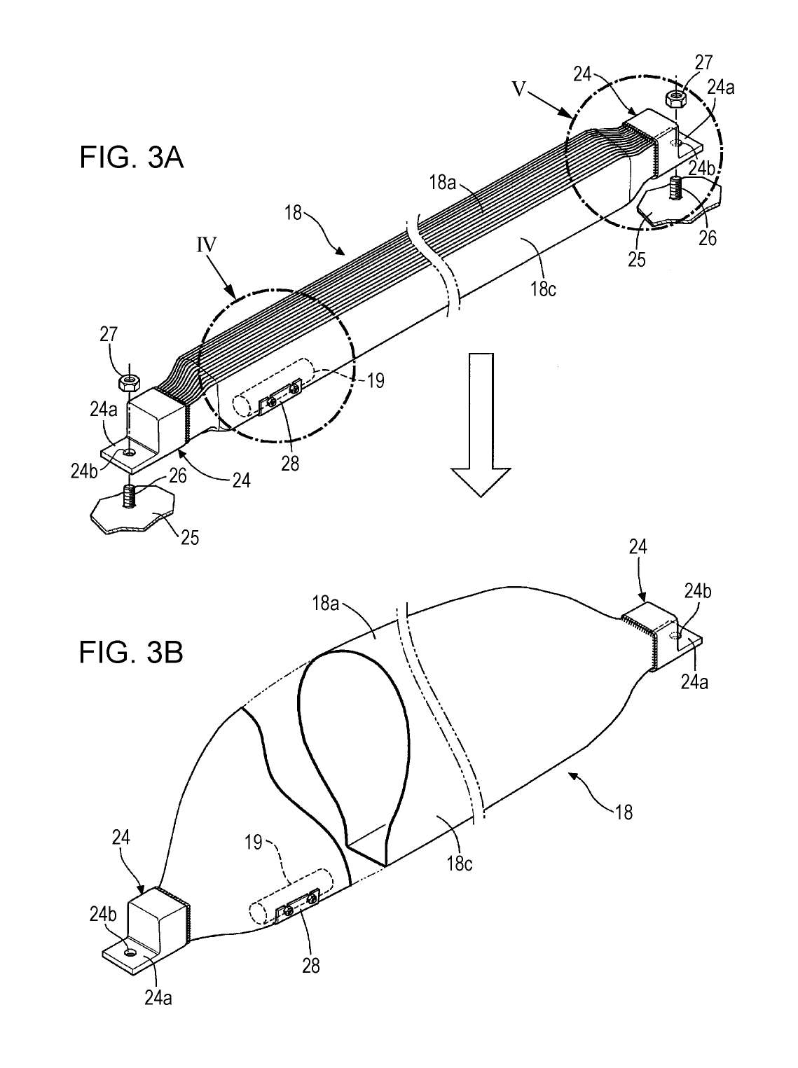

Referring to FIGS. 3A to 5, the ends of the airbag 18 in the folded state are narrowed by being press-formed, and end caps 24 are fitted and welded thereto. Thus, the ends of the airbag 18 are sealed. If the vehicle body has sufficient spaces for receiving the ends of the airbag 18, the ends of the airbag 18 do not need to be narrowed. The end caps 24 have respective mounting portions 24a. The airbag 18 is secured along the front pillar 15 by screwing nuts 27 onto respective bolts 26 that are made to pass through a vehicle body panel 25 and respective bolt holes 24b provided in the mounting portions 24a.

Referring to FIGS. 2 to 4, the inflator-supporting portion 18d of the airbag 18 is provided with an inflator 19 at the bottom thereof. The inflator 19 generates gas with which the airbag 18 is to be deployed. The inflator 19, having a cylindrical shape, is secured to the inner surface of a mounting bracket 28, having a U-shaped cross section, with two securing members 29. The mounting bracket 28 is placed over an opening 18f provided in the inflator-supporting portion 18d of the airbag 18 and is secured thereto with bolts 30 and nuts 31.

Referring to FIG. 2, an outer-panel-side lip 32 is provided at the front end of the outer sidewall portion 18c of the airbag 18 in such a manner as to be in contact with the front face 16a of the outer panel 16. Furthermore, a windshield-side lip 33 is provided at the boundary between the inner sidewall portion 18b and the inflator-supporting portion 18d of the airbag 18 in such a manner as to be in contact with the front face of the side end 12a of the windshield 12. The outer-panel-side lip 32 and the windshield-side lip 33 prevent rain and the like from entering a space produced on the side of the inflator-supporting portion 18d of the airbag 18, thereby protecting the inflator 19.

The behavior of the airbag 18 according to the first embodiment of the present invention configured as described above will now be described.

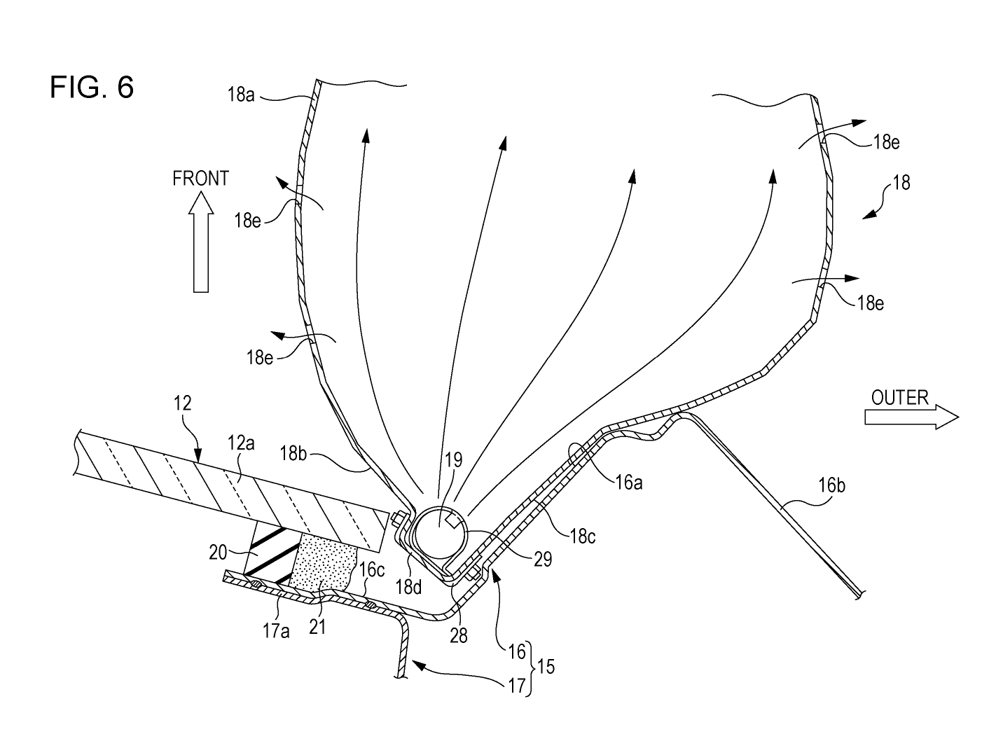

When it is detected that the vehicle has collided with any pedestrian, the inflator 19 is activated and gas is generated, whereby the internal pressure of the airbag 18 increases. With the increase in the internal pressure, referring now to FIG. 6, the zigzag-folded portion 18a, the inner sidewall portion 18b, and the outer sidewall portion 18c of the airbag 18 expand, whereby the airbag 18 is deployed into a tube-like shape over the side end 12a of the windshield 12 and the front face 16a of the outer panel 16 of the front pillar 15.

The zigzag-folded portion 18a of the airbag 18 is folded such that virtual lines connecting the peaks a and valleys b thereof extend substantially in the front-rear direction of the vehicle body. Therefore, the airbag 18 has a larger pressure-receiving area on the side thereof facing the front of the vehicle body and having the peaks a of the zigzag-folded portion 18a than on the sides thereof facing the right and left, respectively, of the vehicle body and having the outer and inner sidewall portions 18c and 18b. Hence, the airbag 18 is deployed more significantly on the side thereof having the zigzag-folded portion 18a facing the front of the vehicle body than on the sides thereof having the inner and outer sidewall portions 18b and 18c facing the right and left of the vehicle body. Thus, the cross section of the airbag 18 that has been deployed has a larger diameter in the front-rear direction of the vehicle body than in the lateral direction of the vehicle body. Consequently, when the pedestrian collides with the deployed airbag 18 from the front side of the vehicle body, the airbag 18 is squashed by a sufficient stroke in the front-rear direction, whereby the impact-absorbing capability thereof is increased.

The perimeter (diameter) of the deployed airbag 18 increases with the length of folds (a length A shown in FIG. 2) of the zigzag-folded portion 18a.

Pedestrian-protecting airbag systems are characterized in that the time period until the pedestrian collides with the front pillar 15 tends to vary relatively significantly with the physique of the pedestrian and the speed of travel of the vehicle at the time of impact. Accordingly, known cloth airbags have a problem in that large-capacity inflators that continuously generate gas are necessary so as to maintain the deployed state of the airbags over a sufficient time period. In contrast, the airbag 18 according to the first embodiment is made of metal, and the deployed state of the metal airbag 18 is therefore maintained even after the supply of the gas is stopped. The airbag 18 absorbs the impact of collision with the pedestrian by undergoing plastic deformation. Hence, the airbag 18 effectively exhibits the impact-absorbing capability thereof with a smaller capacity of the inflator 19, regardless of the timing of impact of the pedestrian on the front pillar 15.

Furthermore, the vent holes 18e of the airbag 18 are provided in the metal-sheet portions of the zigzag-folded portion 18a that are closely in contact with one another between the peaks a and the valleys b. Therefore, at the beginning of deployment of the airbag 18, the gas is hard to be released because the vent holes 18e are closed by the metal-sheet portions residing thereover. This enables the airbag 18 to be deployed quickly. At the end of deployment of the airbag 18, the vent holes 18e are opened, allowing the gas to be easily released. This suppresses an excessive increase in the internal pressure of the airbag 18 while allowing the airbag 18 to be squashed to an appropriate extent upon the impact with the pedestrian. Thus, the impact-absorbing capability of the airbag 18 is increased.

When the airbag 18 is in the folded state, the tips of the peaks a of the zigzag-folded portion 18a and the inner sidewall portion 18b are exposed and are visible from the outside. The tips of the peaks a of the zigzag-folded portion 18a appear to be a substantially flat surface with many parallel strips provided continuously, and the inner sidewall portion 18b is smooth and flat. Therefore, the airbag 18 in the folded state as a whole has an improved appearance with a touch of a pillar garnish.

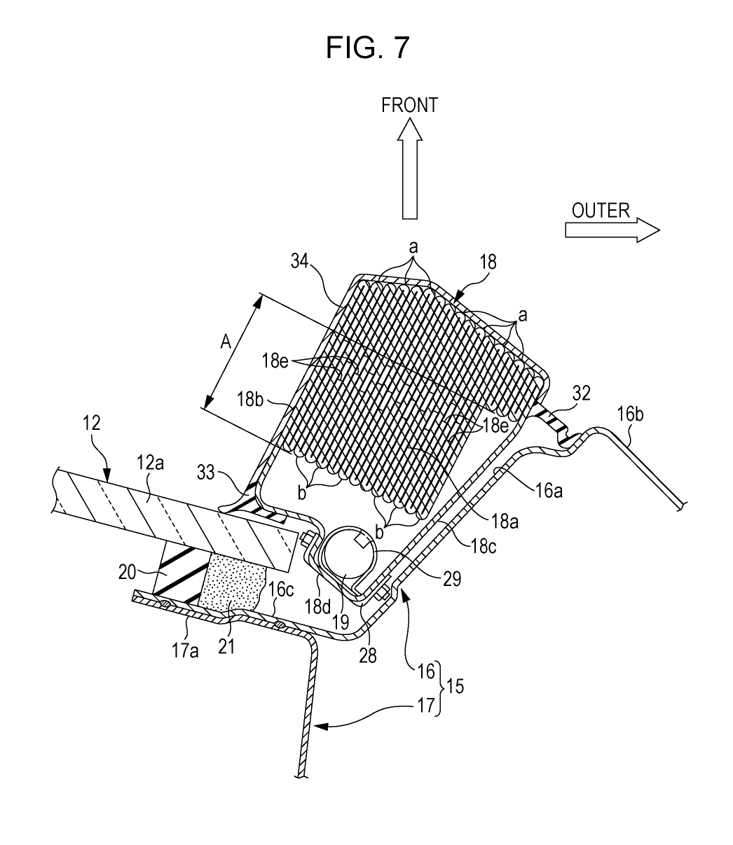

A second embodiment of the present invention will now be described with reference to FIG. 7.

In the second embodiment, a portion of the airbag 18 in the folded state according to the first embodiment that is visible from the outside, i.e., the tips of the peaks a of the zigzag-folded portion 18a and the surface of the inner sidewall portion 18b, are covered with thermoplastic-polyolefin (TPO) resin (soft resin based on polyolefin) 34. Thus, the exposed portions of the airbag 18 in the folded state as a whole appear to be a single member having a smooth surface, providing a more improved appearance.

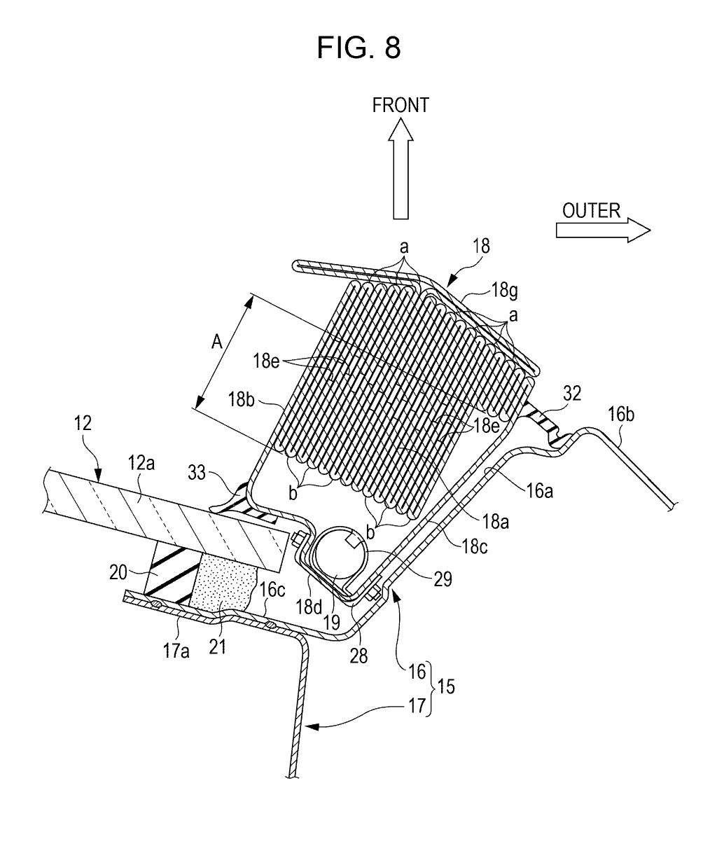

A third embodiment of the present invention will now be described with reference to FIG. 8.

In the third embodiment, the tips of the peaks a of the zigzag-folded portion 18a of the airbag 18 according to the first embodiment is smoothly covered with a covering portion 18g provided by drawing out a part of the zigzag-folded portion 18a toward the front of the vehicle body. Thus, the exposed portions of the airbag 18 in the folded state as a whole appear to be a single member having a smooth surface, providing a more improved appearance.

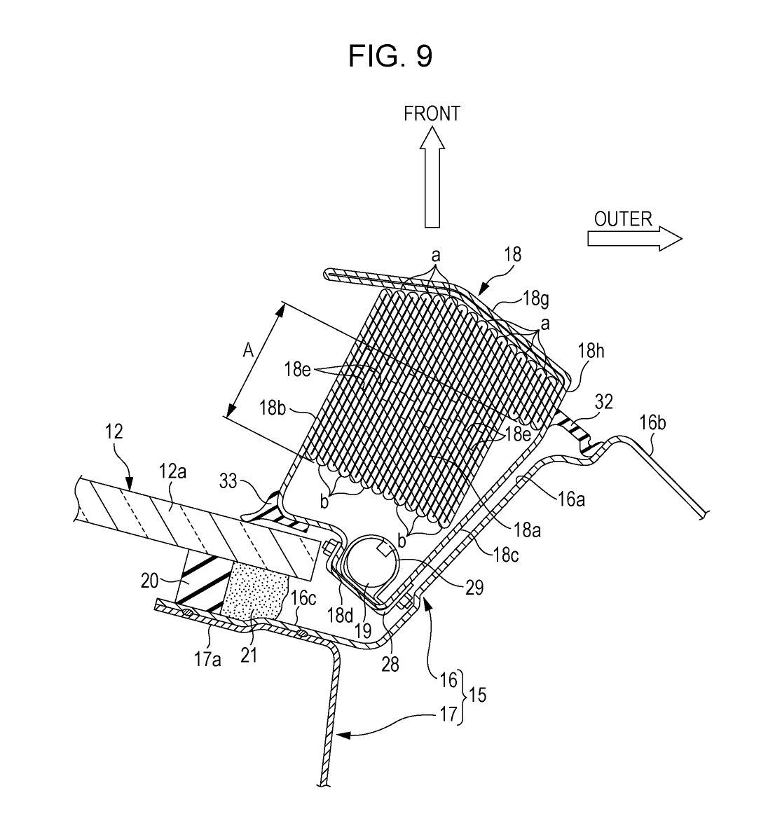

A fourth embodiment of the present invention will now be described with reference to FIG. 9.

In the fourth embodiment, the outer lateral end of the covering portion 18g according to the third embodiment is bent rearward, whereby a corner portion 18h continuous with the front end of the outer sidewall portion 18c is provided. Thus, the boundary between the airbag 18 and the outer panel 16 is made tidy, providing a more improved appearance.

While exemplary embodiments of the present invention have been described above, various design changes can be made thereto without departing from the scope of the present invention.

For example, the virtual lines connecting the peaks a and the valleys b of the zigzag-folded portion 18a of the airbag 18 may be tilted toward right or left by any angle smaller than or equal to 45 degrees with respect to the front-rear direction of the vehicle body.

According to the embodiment of the present invention, since the metal airbags are provided in a zigzag-folded state between the respective side ends, in the lateral direction of the vehicle body, of the windshield of the vehicle and the respective front pillars projecting toward the front of the vehicle body with respect to the side ends, the airbag system is mountable on a known vehicle body without making significant design changes while the beauty of appearance of the vehicle is not reduced even with the airbag system mounted on the vehicle. Furthermore, the metal airbags that has been deployed are hard to be deflated and absorb the impact of collision with the pedestrian by undergoing plastic deformation. Hence, the capacities of the inflators can be reduced, and thus the weights and costs of the airbag system can be reduced. Moreover, the airbag system stably exhibits the impact-absorbing capability thereof, regardless of the timing of impact of the pedestrian. Furthermore, since each of the airbags is folded such that the virtual line connecting each of peaks and one of valleys continuous therewith included in the zigzag folds extends substantially in the front-rear direction of the vehicle body, the side of the airbag facing the front of the vehicle body and having a larger pressure-receiving area with the zigzag folds is deployed more significantly toward the front of the vehicle body. Therefore, when the pedestrian collides with the airbag, the airbag is squashed by a sufficient stroke, whereby the impact-absorbing capability of the airbag is increased.

If each of the airbags has vent holes between the peaks and the valleys, the airbag is deployed quickly at the beginning of deployment thereof because the vent holes are closed. At the end of deployment of the airbag, the vent holes are opened, and an excessive increase in the internal pressure of the airbag is suppressed.

If the tips of the peaks in combination form a surface facing toward the front of the vehicle body, the beauty of appearance of the exposed portions of the airbag in the folded state is increased.

If the tips of the peaks forming the surface are covered with resin, the beauty of appearance of the exposed portions of the airbag is further increased.

If the tips of the peaks forming the surface are covered with the covering portion provided as a part of the airbag, the covering portion serves as a garnish, and the beauty of appearance of the exposed portions of the airbag is further increased.

If the outer end of the covering portion in the lateral direction of the vehicle body is bent toward the rear of the vehicle body along the front pillar, the boundary between the covering portion and the front pillar is made tidy, and the beauty of appearance of the vehicle is further increased.

Obviously, numerous modifications and variations of the present invention are possible in light of the above teachings. It is therefore to be understood that within the scope of the appended claims, the invention may be practiced otherwise than as specifically described herein.

What is claimed is:

1. An airbag system to protect a pedestrian, comprising:
a metal airbag provided in a zigzag-folded state between a side end portion of a windshield of a vehicle and a front pillar projecting toward a front of a vehicle body with respect to the side end portion, the side end portion being an end portion of the windshield in a lateral direction of the vehicle body and being connected to the front pillar; and
an inflator configured to generate gas to deploy the metal airbag along the front pillar,
wherein the metal airbag is folded such that a virtual line connecting each of peaks and one of valleys continuous with the peaks included in zigzag folds extends substantially in a front-rear direction of the vehicle body.

2. The airbag system according to claim 1,
wherein the airbag has vent holes provided between the peaks and the valleys.

3. The airbag system according to claim 1,
wherein tips of the peaks in combination form a surface facing toward the front of the vehicle body.

4. The airbag system according to claim 3,
wherein the tips of the peaks forming the surface are covered with resin.

5. The airbag system according to claim 3,
wherein the tips of the peaks forming the surface are covered with a covering portion provided as a part of the airbag.

6. The airbag system according to claim 5,
wherein an outer end portion of the covering portion in the lateral direction of the vehicle body is bent toward a rear of the vehicle body along the front pillar.

7. The airbag system according to claim 2,
wherein tips of the peaks in combination form a surface facing toward the front of the vehicle body.

8. The airbag system according to claim 7,
wherein the tips of the peaks forming the surface are covered with resin.

9. The airbag system according to claim 7,
wherein the tips of the peaks forming the surface are covered with a covering portion provided as a part of the airbag.

10. The airbag system according to claim 9,
wherein an outer end portion of the covering portion in the lateral direction of the vehicle body is bent toward a rear of the vehicle body along the front pillar.
